(19) United States
(12) Patent Application Publication
(10) Pub. No.: US 2023/0017168 A1
(43) Pub. Date: Jan. 19, 2023

(54) DEVICE FOR CONNECTING A LABORATORY ANIMAL TO AT LEAST ONE EXPERIMENTATION SYSTEM AND METHOD FOR FASTENING SUCH A DEVICE

(71) Applicants: PARIS SCIENCES ET LETTRES, Paris (FR); Centre National de la Recherche Scientifique, Paris (FR); INSERM (Institut National de la Sante et de la Recherche Medicale), Paris (FR)

(72) Inventors: Cathie VENTALON, Paris (FR); Laurent BOURDIEU, Parisfr (FR); Jean-François LEGER, SCEAUX (FR); Jozsua FODOR, BAGNOLET (FR)

(21) Appl. No.: 17/757,667

(22) PCT Filed: Dec. 21, 2020
(86) PCT No.: PCT/EP2020/087524

§ 371 Date: Jun. 17, 2022

(30) Foreign Application Priority Data
Dec. 20, 2019 (FR) FR1915255

(51) Int. Cl. A01K 15/04; A01K 1/03; A01K 1/06

(52) U.S. Cl. CPC A01K 15/04; A01K 1/03; A01K 1/0613

(57) ABSTRACT

A device for connecting a laboratory animal to at least one experimentation system including a body provided with a base for fastening to a bone surface of the animal and at least one element for connection to the experimentation system. The base comprises a perforated fastening structure that has a proximal face with a shape complementary to that of the bone surface and, opposite the proximal face, a distal face that delimits at least two fastening openings emerging at the proximal and distal faces. A method for fastening such a device to a laboratory animal is also disclosed.

### TECHNICAL FIELD

The present invention relates to the technical field of laboratory equipment, and in particular laboratory equipment for animal experimentation. In particular, the invention relates to a device for connecting a laboratory animal to an experimentation system, as well as to a method for attaching such a device to a laboratory animal.

### TECHNOLOGICAL BACKGROUND

In the field of animal experimentation, and especially in the field of experimentation on rodents such as mice and rats, it is known to attach a device to the animal, especially to its skull, in order to be able to immobilize the animal by connecting the device to a restraining system. Such a device is permanently fastened to the animal and therefore remains on the animal between experiment sessions.

Conventionally, such a device is in the form of a plate with an opening delimiting an observation area on the animal's skull and extending on both sides of the animal's head. The plate has means of fastening to the restraint system, for example a screwing system.

These existing devices have the disadvantage of being cumbersome. Thus, the presence of such a device on the animal hinders its sensory input and social interactions. In addition, the bulk formed by the device greatly hinders the placement of experiment devices, such as probes, near the animal.

In addition, the use of such a device can be tedious, and difficulties in attaching the device to the animal can cause stress and physical suffering to the animal. In addition, the imprecise fastening of such a device to a restraint system may in some cases make reproducibility of experimental conditions difficult or impossible.

There is therefore a need for a device that is not cumbersome, not very stressful for the animal, easy to set up on the animal, and allows for good reproducibility of the experimental conditions.

### SUMMARY OF THE INVENTION

In order to achieve these objectives, the invention concerns a device for connecting a laboratory animal to at least one experimentation system, comprising a body provided with

a base for fastening to a bone surface of the animal,
at least one element for connection to the experimentation system,
characterized in that the base comprises a perforated fastening structure which has a proximal face with a shape complementary to that of the bone surface and, opposite the proximal face, a distal face that delimits at least two fastening openings emerging at the proximal and distal faces.

The use of a perforated fastening structure conveniently allows a simplified and reliable fastening of the base onto the bone part of the animal.

Indeed, when the base is fastened to the bone part by means of a cement, that is, a curable adhesive substance such as a light-curing resin such as those used as dental cement, the fastening openings allow for a more uniform illumination of the resin and thus a more uniform polymerization than would be obtained without the fastening openings. It should be noted that when using a solvent-based glue to fasten the base on the animal's bone, the fastening openings facilitate the evaporation of the solvent, thus contributing to a rapid setting of the glue. In addition, the fastener openings increase the contact area between the fastener adhesive and the edges of the base, which contributes to the strength of the fastener.

In addition, the shape of the proximal face of the fastening base complements that of the bone surface, making it possible to obtain a large contact surface between the adhesive and the device at the interface between the latter and the bone surface, and thus contributing to a strong attachment of the device according to the invention on the animal.

Furthermore, a base shape complementary to the bone surface allows for a reduction in the thickness of adhesive applied between the device and the bone surface. The volume of cement used, and therefore the weight borne by the animal, is thus advantageously reduced. Moreover, the smaller the volume of cement used, the smaller the deformation caused by the possible shrinkage of the cement during its curing, thus ensuring a better fastening of the device.

For the purposes of the invention, a fastening opening may be defined by a continuous or closed peripheral wall, in which case it is possible to speak of a fastening window, or it may be defined by an unclosed peripheral wall, in which case it is possible to speak of a fastening notch, for example in the shape of a “C” or “U” or even “V”. A perforated fastening structure according to the invention may therefore comprise a plurality of fastening openings formed exclusively as fastening windows or notches. However, a perforated fastening structure according to the invention may also comprise one or more fastening windows and one or more fastening notches.

According to one feature of the invention, the base comprises at least one reinforcing rib from which the perforated fastening structure extends. The use of such a reinforcing rib increases the rigidity of the base.

According to another feature of the invention, the perforated fastening structure comprises a lattice, the branches of which at least partially delimit the fastening openings. In the context of the invention, the notion of lattice in the broadest sense should be understood as being, for example, a network of branches or small ribs delimiting openings of varying sizes and shapes or as being a network of openings of varying or unvarying shapes. Thus, a perforated structure with multiple openings forms a lattice For the purposes of the invention. In the context of the invention, the branches and/or ribs making up the lattice are not necessarily straight but can also be curved or sinuous.

The use of a lattice makes it possible, with at least equivalent mechanical strength and rigidity, to reduce the weight of the device according to the invention and thus the discomfort of the animal wearing it. In addition, the perforated nature of the lattice increases the penetration of the fastening adhesive, or cement, into the structure of the base, thus increasing the quality of the fastening. Furthermore, when using a light-curing adhesive, the strongly perforated nature of the lattice structure allows for better illumination of the adhesive at the interface between the fastening base and the animal's bone.

According to yet another feature of the invention, the base comprises at least one observation frame which emerges at the proximal and distal faces and which has a larger passage cross-section than the passage cross-section of the fastening openings. The implementation of such an observation frame advantageously allows to delimit an observation area on the bone surface of the animal. In addition, when the observation area has a viewing window built into the animal's bone mass, the observation frame glued to the bone surface helps reinforce the open bone region. Alternatively, the passage cross-section of the observation frame can be smaller than or equal to the passage cross-section of the fastening openings.

According to one embodiment of the invention, each fastening opening has a smaller passage cross-section at the proximal face than the passage cross-section of said opening in at least one other level of the fastening opening. Such a size reduction enables, after the fastening adhesive has set and hardened in the fastening opening, a more resistant positive locking of the base by the adhesive than what would result merely from the bonding of the adhesive.

According to a variant embodiment, each fastening opening has a peripheral wall that converges toward the proximal face. In other words, the fastening openings have a cross-section passage which continuously decreases from the distal surface to the proximal surface. This may be referred to as an undercut shape.

According to one feature of the invention, the proximal face of the fastening base has a generally concave shape. Such a general shape is particularly suitable for a device according to the invention intended to be fastened to the cranium of an animal. Of course, a device according to the invention is not necessarily fastened to the cranium and may be intended to be fastened to other bone structures.

According to another feature of the invention, the body comprises, as a connection element, at least one cradle for receiving an experimentation system. Such a cradle then allows an experimentation system, for example a probe or an electronic connector, to be fastened directly to the device according to the invention, that is as close as possible to the animal. This contributes advantageously to simplifying experiments carried out on animals.

According to one embodiment, said at least one receiving cradle is configured to provide electromagnetic isolation to the experimentation system

According to yet another feature of the invention, the body comprises, as a connection element, a head for securing to an external restraining system. The use of such a restraining head makes it possible, when the device according to the invention is fastened on the animal, to immobilize the bone region of fastening, which makes it possible to intervene on that region or to carry out observations under good conditions. In addition, the restraining head allows the observation conditions to be reproducible when observation phases are carried out at different times.

According to a variant of this feature, the restraining head has a dovetail shape, that is comprises a pin with a trapezoidal cross-section, intended to fit into a complementary groove of the restraining system. Such a dovetail shape allows for simple and fast fastening into the corresponding groove of the restraining system. In addition, the dovetail shape allows for precise fastening of the device and thus good reproducibility of the fastening position. This improves the reproducibility of the experimental conditions.

According to another variant of this feature, the body of the device comprises an arm connecting the fastening base to the restraining head. Such an arm advantageously allows the restraining head to be moved away from the base, that is, to place the restraining system at a distance from the bone surface of the animal. Thus, the space around the bone surface is advantageously freed up and is accessible for experimentation systems.

According to one embodiment of the invention, the arm has a box-like structure. Such a box-like structure has the advantage of being lightweight while offering significant rigidity. The lightness contributes to the comfort of the animal while the rigidity favors an effective immobilization of the bone part on which the base is fastened.

According to a variant of this embodiment, the arm has a lattice structure. Such a lattice structure makes the box structure of the arm even lighter.

According to yet another variant of this embodiment, the right cross-section of the arm increases from the fastening base towards the restraining head. Such a configuration makes it possible to ensure a good rigidity of the arm while enabling a smaller arm-to-base connection zone.

According to one variant of this embodiment, the arm extends in a sagittal plane of the device body. Such a configuration is particularly suitable when the device according to the invention is intended to be fastened to the cranium of an animal. It is then possible to make the sagittal plane of the device coincide with the sagittal plane of the cranium, which contributes to the animal's comfort.

Within the content of this variant and according to a preferred embodiment, the arm extends along an axis that forms, in the sagittal plane, a non-zero angle with a normal to the proximal face of the fastening base. The device can then be fastened to the animal in such a way as to extend towards the rear of the latter, which limits the discomfort induced by wearing the device according to the invention. Moreover, when fastened to the cranium, this configuration prevents the arm from interfering with the experimentation systems.

According to a variant of embodiment, the arm comprises an auxiliary observation frame configured to provide visual access to the fastening base. Thus, the arm does not obstruct the view of the fastening base. According to one embodiment, the auxiliary observation frame is configured to provide visual access to the animal observation area.

According to a variant of embodiment, the observation frame extends into the arm.

According to an embodiment, the device comprises means for fastening at least one protective cover. A protective cover is particularly advantageous to protect the animal between experiments.

According to a variant embodiment, the device comprises at least one means for attaching a ballast for modifying the center of gravity of the device.

The invention also relates to a method of fastening a device according to the invention to a laboratory animal, the method comprising
applying a cement to the proximal face of the device,
placing the fastening base onto the bone surface of the laboratory animal so that the proximal face conforms to the bone surface,
curing the cement.

According to an implementation feature of the method, the cement is a light-curing cement and the curing involves illumination of the cement at least through the fastening openings. For example, the illumination can be ultraviolet illumination.

Thus, the presence of the fastening openings allows a deeper and more uniform illumination of the cement and thus a better curing thereof than would be possible without the fastening openings. This improves the fastening of the device.

According to one feature of implementation of the method, the cement is applied in an amount sufficient to penetrate the interior of the fastening openings. Thus, the cement is in contact with the peripheral walls of the fastening openings. The fastening of the device is thus improved by the bonding of the cement to the peripheral walls and/or by anchoring the cement to the peripheral walls when they have an undercut shape.

The invention also relates to a device for connecting a laboratory animal to an experimentation system, comprising a body provided with
a base for fastening to a bone surface of the animal,
an element for connection to the experimentation system, the fastening base and the connection element being connected by an arm having a box-like structure.

As previously mentioned, the arm advantageously keeps the connection element away from the base, that is, keeps the restraining system away from the bone surface of the animal. Thus, the space around the bone surface is advantageously freed up and can be occupied by other experimentation systems. Furthermore, a boxed arm structure makes the device lighter and therefore more comfortable for the animal.

In this other aspect of the invention, the base is not necessarily perforated and can have any suitable configuration.

Furthermore, still within the framework of this other aspect of the invention, the arm is likely to have the different forms and variant embodiments described previously and hereafter.

Of course, the various features, variants and embodiments of the invention may be combined with each other in various combinations as long as they are not incompatible or exclusive of each other.

### BRIEF DESCRIPTION OF THE FIGURES

Furthermore, various other features of the invention are apparent from the appended description made with reference to the drawings which illustrate non-limiting forms of embodiment of the invention and wherein:

FIG. 1 is a schematic perspective view of a fastening device according to the invention,

FIG. 2 is a bottom view of the device in FIG. 1,

FIG. 3 is a top view of the device in FIG. 1,

FIG. 4 is a side view of the device in FIG. 1,

FIG. 5 is a cross-sectional view of a portion of the fastening device of FIG. 1,

FIG. 6 shows an example use of the device of FIG. 1,

FIG. 7 shows a method of fastening a device according to the invention,

FIG. 8 shows a cross-sectional view of the portion of the device shown in FIG. 2, fastened to a bone surface of an animal,

FIG. 9 shows a variant of the device according to the invention,

FIG. 10 shows another variant of embodiment of the device according to the invention,

FIG. 11 shows yet another variant of the device embodiment according to the invention,

FIG. 12 is a schematic cross-section, similar to FIG. 5, showing a method of fastening the connecting device shown in FIGS. 1 to 4 with a cement reinforced with one or more intraosseous screws,

FIG. 13 shows another variant of the device embodiment according to the invention,

FIG. 14 shows the variant embodiment of FIG. 13

FIG. 15 shows the variant embodiment of FIGS. 13 and 14

FIG. 16 shows the variant embodiment of FIGS. 13 to 15

It should be noted that in these figures the structural and/or functional elements common to the different variants may have the same references.

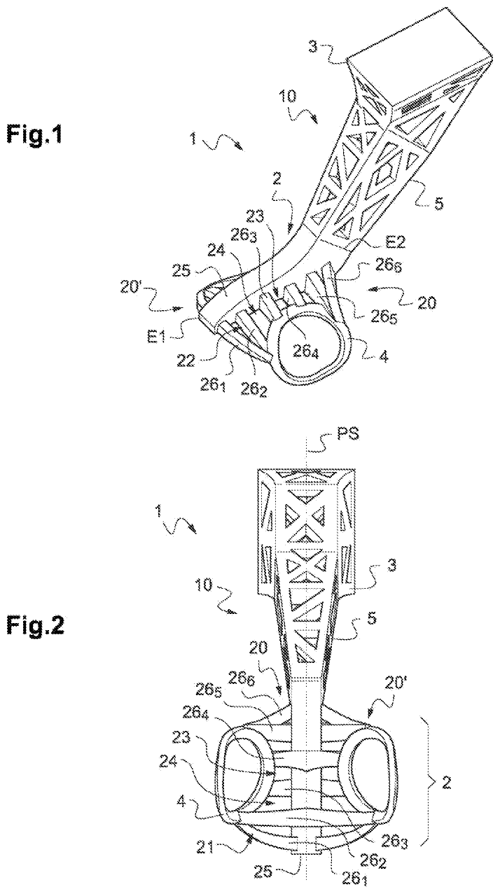

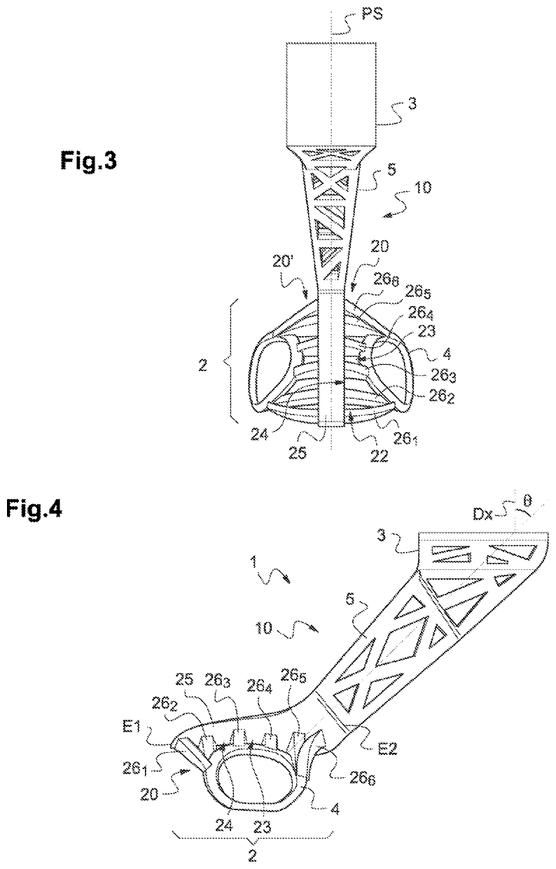

A connecting device according to the invention, as shown in FIGS. 1 to 4 and referred to as a whole by reference 1, comprises a body 10 comprising a base 2 for fastening to a bone surface of an animal and an element 3 for connection to at least one experimentation system.

The base 2 comprises an perforated fastening structure 20 that has a proximal face 21 intended to form a contact surface with the bone surface, and a distal face 22 opposite the proximal face 21. The proximal face is here configured to conform to the surface of the animal's skull and thus has a generally concave shape here. Alternatively, the proximal face 21 could be adapted to any other bone structure and have any other general shape.

The perforated fastening structure 20 herein delimits a plurality of fastening openings 23, 24, herein fastening windows, only two of which are referenced herein for simplicity's sake. Each of the fastening openings extends through the opening structure 20 so as to open at the proximal 21 and distal 22 faces.

In the shown embodiment, the base 2 has a reinforcing rib 25 from which the perforated fastening structure 20 extends. Here, the fastening base 2 is symmetrical with respect to the reinforcing rib 25, and more specifically with respect to a plane of symmetry wherein the reinforcing rib 25 extends. The base 2 therefore has another perforated fastening structure 20′ so that the identical perforated fastening structures 20 and 20′ extend on either side of the reinforcing rib 25. For simplicity's sake, only the perforated structure 20 will be described here.

The plane of symmetry forms a sagittal plane PS, or median plane, of the body 10 of the device 1. And, the device 1 then shown is configured so that, when fastened to the animal, the sagittal plane PS of the body of the device is coincident with the sagittal plane of the animal.

Alternatively, it would be possible for the device 1 to have only one opening structure, for example the opening structure 20, or for the base 2 to have no reinforcing rib.

Here, the reinforcing rib 25 has a thickness that increases in the longitudinal direction between a first end E1 of the reinforcing rib and a second end E2 of the reinforcing rib 25. The perforated structure 20 has a decreasing thickness in a direction orthogonal to the reinforcing rib 25. Alternatively, it would be possible for the reinforcing rib 25 to have a constant thickness and/or the perforated structure 20 to have a constant thickness.

At the first end E1, the reinforcing rib 25 has a thickness slightly greater than the thickness of the perforated structure 20. For example, the reinforcing rib has, at its first end E1, a thickness of 0.94 millimeter, and the perforated structure 20 has, at its junction with the reinforcing rib 25, a thickness of 0.6 millimeter.

At the second end E2, the reinforcing rib 25 has a thickness at least twice as large as the thickness of the perforated structure 20. For example, at the second end E2, the reinforcing rib 25 has a thickness of 3.6 millimeters, and the perforated structure 20 has, at its junction with the reinforcing rib 25, a thickness of 1.1 millimeters.

According to the shown variant, the perforated structure comprises a lattice, the branches of which delimit the fastening openings 23, 24. For example here, the perforated structure 20 has on each side of the reinforcing rib 25, six branches 26₁ to 26₆, which extend transversely from the reinforcing rib 25. The ends of the branches opposite the ends joining the reinforcement structure are integral. Alternatively, the perforated structure 20 could comprise any other structure, for example a perforated envelope.

Here, the thickness of each branch decreases longitudinally with distance from the reinforcing rib 25. For example, the branches have a thickness of between 0.6 millimeters and 0.9 millimeters at the end where they meet the reinforcing rib 25, and a thickness of between 0.3 millimeters and 0.4 millimeters at the opposite end.

In this embodiment, the base 2 has an observation frame 4. The observation frame 4 is open at the proximal face 21 and at the distal face 22. The observation frame differs from the fastening openings 23, 24 in its dimensions. Here, the observation frame 4 has a generally circular passage cross-section with a maximum dimension, or maximum diameter, of 5 millimeters.

The dimensions of the observation frame 4 are preferably chosen so that the fastening frame 4 can delimit an observation area, for example a hole made in the bone surface of the animal. In particular, the dimensions of the observation frame 4 can be preferably chosen so as to maintain a distance of about 1 millimeter between the edge of the hole and the observation frame 4.

The observation frame 4 is, according to the shown example, fastened to an end of the opening structure 20 opposite the end of the opening structure 20 joining with the reinforcing rib 25, that is to the end of the branches 26₁ to 26₆ so that the ends of the branches 26₁ to 26₆ are mutually joined by the observation frame 4. And, since the observation frame 4 is generally circular, the branches 26₁ to 26₆ here have different lengths depending on where they join the observation frame 4.

Alternatively, some branches could not be mutually joined but have a free end.

The observation frame 4 has a constant thickness here, but could alternatively have a non-constant thickness, for example a thickness that decreases further from the reinforcing rib 25.

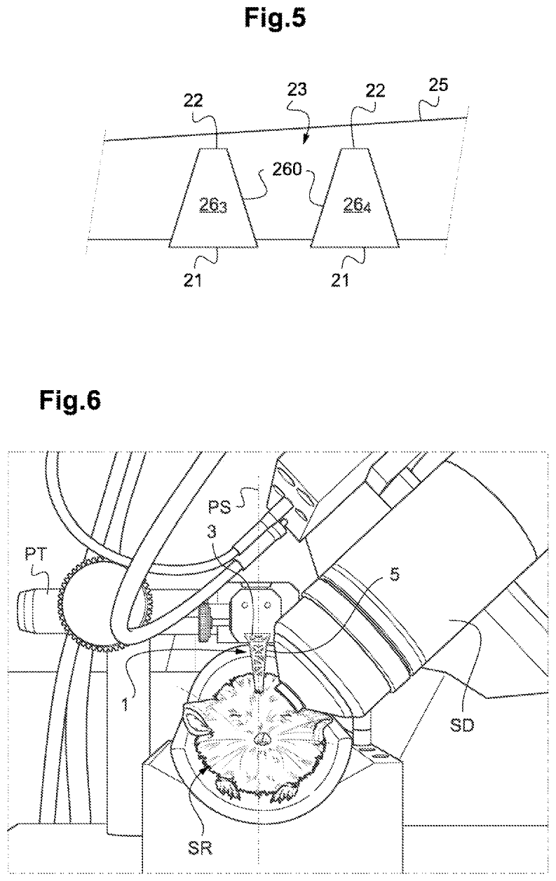

FIG. 5 is a cross-sectional view of the fastening opening 23 and the branches 26₃, and 26₄ along a sectional plane orthogonal to the longitudinal directions of the branches 26₃ and 26₄.

The fastening opening 23 has a passage cross-section that varies in size between the proximal face 21 and the distal face 22. In particular here, the passage cross-section of the fastening opening 23 at the proximal face 21 is smaller than the passage cross-section at the distal face 22. In other words, here, the fastening opening 23 is laterally bounded by a peripheral wall 260 that converges toward the proximal face 21.

According to the shown example, the variation of the dimensions of the passage cross-section of the fastening opening results from the shape of the branches delimiting said opening, which have a trapezoidal cross-section.

However, such an embodiment is not strictly necessary. Thus, the variation in the dimensions of the passage cross-section of the window 23 can also result from the shape of the reinforcing rib 25, which could have a straight trapezoidal cross-section. The variation of the dimensions of the passage cross-section of the window 23 could also result from the shape of the cross-section of the observation frame 4.

Alternatively, the cross-sectional area of the fastening opening 23 could vary differently. For example, the passageway section could have identical dimensions at the proximal 21 and distal 22 faces, and a larger dimension at an intermediate level between the proximal 21 and distal 22 faces.

According to the shown embodiment, each of the fastening openings has the configuration of the fastening opening 23 described in connection with

FIG. 5, and has a passage cross-section whose dimensions vary, here decreasing between the distal face 22 and the proximal face 21. Alternatively, it would be possible for only some or one window to have this configuration.

In the present case, the connection element 3 is formed by a restraining head secured to an immobilization system (not shown). The restraining head here has a dovetail shape and is configured to be inserted into a complementary groove of the immobilization system.

In addition, the body 10 has an arm 5 connecting the fastening base 2 to the restraining head 3. Thus, a first end of the arm 5 is connected to the fastening base 2, here to the second end E2 of the reinforcing rib 25 so that the arm forms an extension of the reinforcing rib 25. A second end of the arm opposite the first end is connected to the restraining head so that the dovetailed restraining head 3 forms an extension of the arm 5. The arm 5 has a length of 13 millimeters, but could have any other length, preferably a length between 10 millimeters and 30 millimeters. Alternatively, the device 1 could exclude the arm 5, and the restraining head 3 could be connected directly to the base 2, for example connected to the second end E2 of the reinforcing rib 25 so as to form an extension of the reinforcing rib 25.

The arm 5 extends in the median plane PS of the body of the device from the reinforcing rib 25 and forms an angle θ of 45° with a direction Dx normal to the proximal face 21. Alternatively, the arm 5 could form a different angle with the direction Dx, for example an angle between 0° and 90°. The arm 5 could also form an angle with the median plane PS.

The arm 5 has a box-like structure, that is a hollow structure. According to the shown example, the arm also has a three-dimensional lattice structure.

The cross-section of the arm 5 is rectangular or even square in shape, and its dimensions increase progressively with the distance away from the base 2. Thus, at its junction with the reinforcing rib 25, the arm 5 has a rectangular cross-section of 2 millimeters by 3.5 millimeters, and at its junction with the restraining head, a rectangular cross-section of 4 millimeters by 5 millimeters.

Alternatively, the arm 5 could have any other structure with any other cross-sectional shape, including a solid structure, a flat structure, a tubular structure, a T-beam or double-T structure, etc.

The device according to the invention may be made of any suitable material, preferably biocompatible. According to the shown example, the body is made of metal and more particularly of titanium. According to the example described above, the device according to the invention is monolithic, that is the body 10 comprising the fastening base, the arm, and the restraining head form a single piece. The monolithic body 10 can be made by any suitable manufacturing or machining process. Preferably, the monolithic body is obtained by 3D printing, which allows a great freedom of shape, especially on the proximal face of the fastening base. Of course, the body 10 of the device according to the invention is not necessarily monolithic

The device according to the invention, as previously described in connection with FIGS. 1 to 5, can be implemented in the following manner. According to the implementation example shown in FIG. 6, the device 1 is fastened to the skull box of a mouse SR in such a way that the base conforms to a bone surface of the mouse SR, in this case on the surface of the skull of the mouse SR. The restraining head 3 is here inserted into a groove of a fastening system, for example here a stem head PT, and held immobile in said groove by clamping.

Here, the device 1 is placed on the mouse SR in such a way that the sagittal plane of the mouse and the sagittal plane PS of the body 10 of the device 1 are coincident, and in such a way that the arm 5 extends posteriorly in the sagittal plane of the mouse SR.

An observation probe SD, here an optical microscope lens, is placed in this example opposite the observation frame 4.

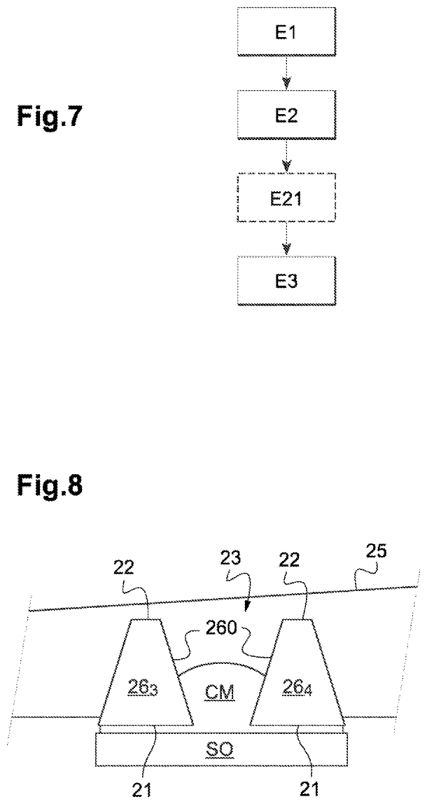

A method of fastening the device 1 to the bone surface is shown in FIG. 7. A first step E1 involves the application of an adhesive substance, such as cement, to the proximal surface 21. For example, the cement may comprise a light-curing resin, a solvent-based adhesive, an adhesive curable by chemical reaction between its components, or any other compatible adhesive substance.

A second step E2 involves placing the device 1 on the bone surface, so that the proximal face 21 conforms to the bone surface.

The method of fastening the device 1 comprises an optional step E21 of applying cement to the peripheral walls of the fastening openings. This step is shown as a dotted line in FIG. 7.

For example, the optional step E21 may comprise applying cement to the fastening openings such that the cement covers the bone surface bounded by the fastening opening and at least partially covers the peripheral wall 260. Alternatively, the fastening device 1 may be pressed lightly against the bone surface so that a portion of the cement applied to the proximal face 21 is pressed into the fastening openings so as to cover the peripheral wall 260 thereof.

A third step E3 involves a curing of the cement. Depending on the nature of the cement used, the curing of the cement can be achieved passively, for example by evaporation of a solvent present in the cement. Preferably, a light-curing cement is used, so that the setting of the cement is activated by illumination, for example ultraviolet, through the fastening openings 23, 24 in particular. Alternatively, the illumination could be of a different nature, including visible illumination, such as blue light.

FIG. 8 is a cross-sectional view of the fastening opening 23 and the branches 263, 264 along a sectional plane orthogonal to the longitudinal directions of the branches 263 and 264, after the implementation of the method previously described in connection with FIG. 4. The device is fastened to the animal's bone surface SO, and cement CM is applied between the proximal face 21 and the bone surface SO. A portion of the cement CM extends into the fastening opening 23 so as to cover the peripheral wall 260 thereof.

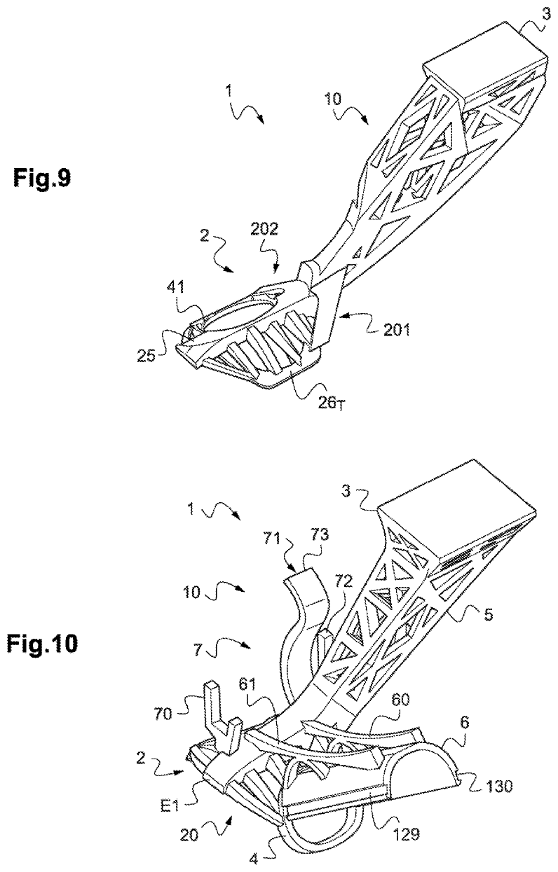

According to the example described above, the base is symmetrical relative to the sagittal plane. However, such a configuration is not essential. Thus, FIG. 9 shows an alternative embodiment of the device according to the invention in which the base 2 is not symmetrical with respect to the sagittal plane PS. According to this embodiment, the base 2 comprises a first perforated structure 201 extending on a first side of the rib 25, here a lattice structure whose branches are mutually joined at their opposite ends at their junction with the rib 25 by a transverse branch 26T.

The base 2 further comprises a second perforated structure 202 and an observation frame 41 extending from the reinforcing rib 25 and which is partially delimited by the reinforcing rib 25. In other words, the observation frame 41 extends partially into the reinforcing rib 25.

According to the invention, the connection element is not necessarily formed by a restraining head. Thus, FIG. 10 shows an embodiment wherein the device 1 has, as a connection element, two receiving cradles of an experimentation system.

A first receiving cradle comprises a receiving sleeve 6 for a longitudinal element, for example here an electrophysiological implant electrode (not shown). The receiving sleeve 6 extends from the perforated structure 20, and more specifically here from the observation frame 4. The sleeve 6 is here shaped like a hollow half-cylinder and has an end that hugs a portion of the observation frame 4 and is integral with it. Alternatively, the sleeve could have any other suitable shape, including a complete hollow cylinder shape, a cone shape or a half-cone shape.

The sleeve comprises reinforcing bars 60, 61 making it possible to reinforce the strength of the sleeve 6 and to prevent it from deforming under the action of mechanical stresses, for example mechanical stresses generated by the fastening of the implant electrode or by an external shock produced on the implant when the animal moves.

Alternatively, the sleeve 6 could be located at another location on the base 2, for example at the first end E1 of the reinforcing rib 25.

Here, the sleeve 6 has two fastening grooves 129, 130 configured to fasten a protective cover, for example by receiving corresponding tabs of the protective cover. For example, the protective cover may obstruct the observation frame 4 in order to protect the animal between experiments, especially in the case where an observation window is provided in the animal's bone mass.

A second receiving cradle has a receiving base 7 for an electronic board. Here, the receiving base 7 has two support slots 70 and 72 directly fastened to the rib and having a U shape. The support slots are configured to receive a portion of the electronic board.

The receiving base further comprises a support clamp 71 comprising a portion of the arm 5 resting on a first face of the electronic board and an elastic arm 73 configured to exert a clamping force by elasticity on a second face of the electronic board opposite the first face. Thus the support clamp 71 is configured to hold the electronic board in place by clamping between the arm 5 and the elastic arm 73.

According to the embodiment shown in FIG. 10, the connecting device 1 further comprises the restraining head 3 and the arm 5 as previously described in connection with FIGS. 1 to 4. However, the connecting device according to the invention could exclude the restraining head 3 or the arm 5, thereby comprising only the two receiving cradles 6 and 7, or a different number of receiving cradles, for example, a single receiving cradle, or even connection elements with different structures.

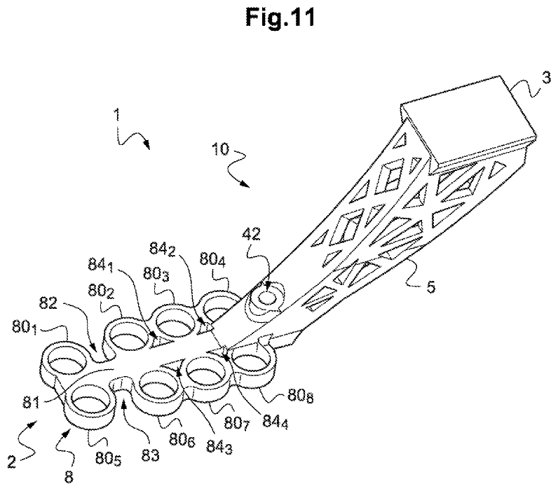

According to the examples described above, the perforated structure of the base is formed by a lattice. However, the use of such a lattice is not strictly necessary for the formation of the perforated structure. Thus, FIG. 11 shows an embodiment of the invention wherein the fastening base 2 comprises a perforated structure comprising an assembly 8 of rings. Here, the assembly 8 has eight rings 801 to 808 arranged symmetrically about a central strip 81 extending in the sagittal plane PS of the device body.

The central band 81 and the rings 801 to 808 have the same thickness, here a thickness of 1 millimeter.

The device according to this embodiment comprises first fastening windows formed by the rings 801 to 808, second fastening windows formed by gaps 841, 843, 843, 845 between the rings and the central strip 81, as well as two fastening notches 82, 83.

A hole 42 through the arm 5 serves here as an observation frame and as an element for connection to an experimentation system. In particular, the hole 42 is adapted to receive an optical fiber (not shown) by inserting one end of the fiber into the hole 42.

Of course, various other modifications may be made to the invention within the scope of the appended claims. Thus, while a perforated structure comprising a lattice and a perforated structure comprising a ring assembly have been described, embodiments of the invention may comprise perforated structures of any other type, including combinations of perforated structures, for example a combination of lattice and ring. And, although a fastening frame with a larger passage cross-section than the passage cross-section of the fastening openings has been described, it is perfectly possible to envisage a observation frame with the same or a smaller passage cross-section than the passage cross-section of the fastening openings.

Furthermore, according to the embodiment and implementation example described in connection with FIGS. 1 to 5, the connecting device according to the invention is fastened to the bone of the laboratory animal only by means of cement. However, the invention is not exclusive of other means of fastening.

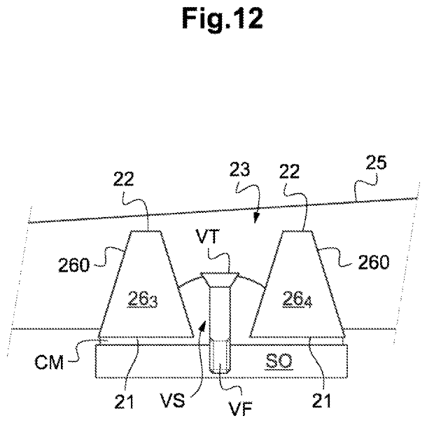

Thus, as shown in FIG. 12, it is possible to reinforce the cement's bond on the bone surface SO by using a screw VS comprising a head VT and a threaded part VF.

According to this embodiment, the screw is placed in the fastening window 23 and passes through the cement CM. The threaded part VF is screwed into the bone surface SO and the head VT is at a non-zero distance from the bone surface SO, for example here at a distance of 0.5 millimeter. The cement CM's hold on the bone surface SO is therefore reinforced by its anchoring on the head TV. The anchoring of the device 1 in the cement is therefore improved.

The head VT in this example is a countersunk head, that is truncated cone, but it would be possible to use a screw with any other head shape, for example a cylindrical head.

In particular, this method of fastening is compatible with the fastening method according to the invention and in particular with the embodiment of this method previously described in connection with FIG. 7.

Thus, according to a first variant embodiment of the method, the screw VS can be screwed into the bone surface SO prior to step E2 of placing the device on the bone part, or even prior to step E1. In this case, step E2 involves placing the device on the bone surface in such a way that the fastening window 23 is around the screw.

According to a second variant embodiment, the screw may be placed in the fastening window 23 and screwed into the bone surface SO between step E2 of placing the device on the bone surface SO and step E3 of curing the cement CM. According to this variant, it would be possible to choose a screw with a screw head having a diameter larger than a passage cross-section of the fastening opening, for example larger than the passage cross-section of the fastening opening at the proximal face 21. In particular, the screw head VT could be in contact with the peripheral wall 260 of the fastening window 23, such that the screw directly contributes to holding the device 1 against the bone surface SO by clamping the branches 263 and 264 between the screw head VT and the bone surface SO.

According to the shown example, the threaded part VF of the screw is completely screwed into the bone surface SO. However, if the screw is placed before the cement is, or before the cement hardens, the VF threaded portion may extend outside the bone surface SO. In particular, the screw could be threaded along its entire length. The cement CM would then cooperate with the threaded part VF, thus helping reinforce the fastening of the cement to the bone surface SO.

This screw-reinforced cement fastening method is not limited to the fastening window 23 alone, but is similarly applicable to other fastening openings. This embodiment is also not limited to a perforated lattice structure but is applicable to any perforated structure.

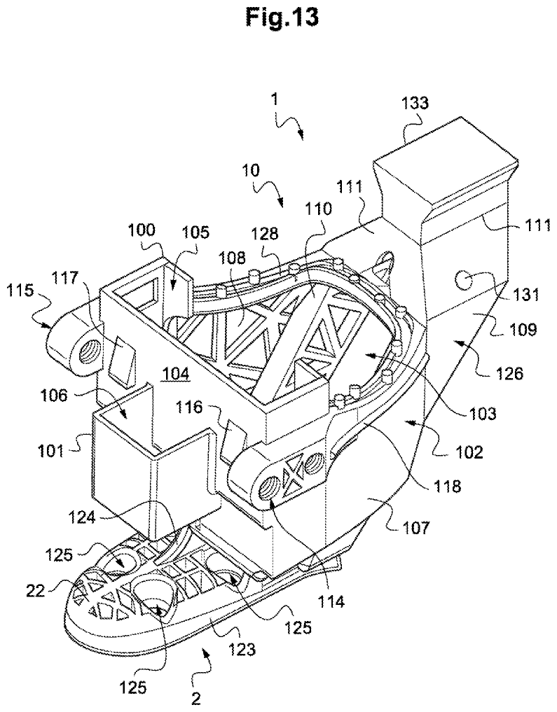

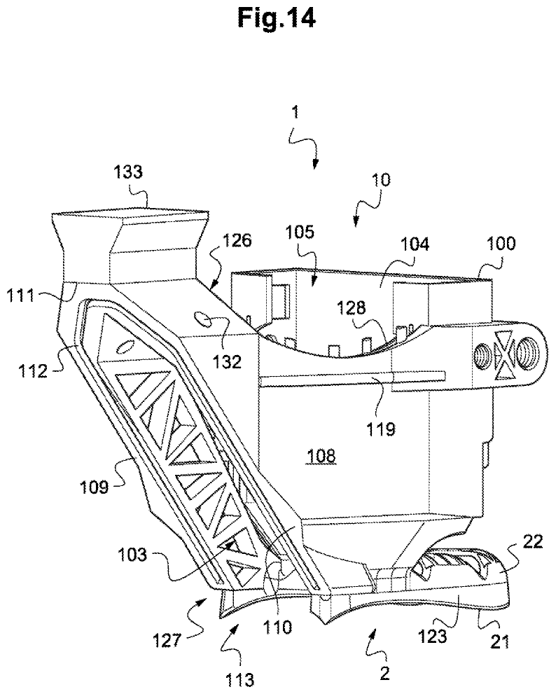

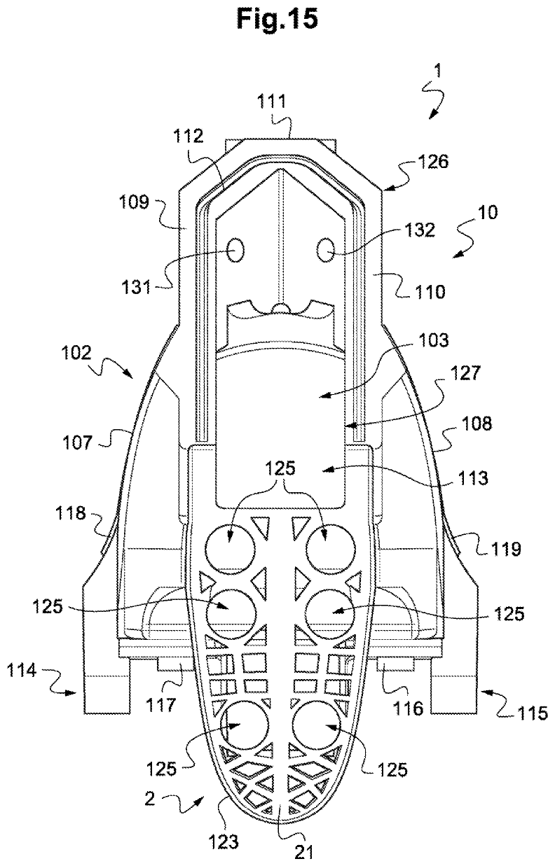

FIGS. 13 to 16 show a variant of the device 1 according to the invention, FIGS. 13, 14 and 16 are perspective views of this device and FIG. 15 is a bottom view.

The body 10 of the connecting device 1 according to this embodiment comprises a base 2 comprising a perforated fastening structure 123 extending on either side of a central rib 124, said base 2 being formed by a lattice wherein six circular fastening openings 125 are provided.

The body 10 of the device 1 according to this embodiment comprises two cradles 100, 101 for receiving experimentation systems, a protective enclosure 102, and an arm 126 comprising an auxiliary observation frame 103. These elements 100 to 103 and 126 described below in connection with the embodiment of FIGS. 13 to 16 are mutually independent and each compatible with the preceding embodiments.

A first receiving cradle of this embodiment comprises a first housing 100, here generally parallelepipedic, directly fastened to the base 2 so as to extend vertically above the base 2, and having a first upper opening 105 adapted to receive an electrical connector of complementary shape to the first housing 100. Here, the first housing 100 is configured to extend in a transverse plane of the animal. A front wall 104 of the receiving housing is configured to be located in a transverse plane of the animal.

A second receiving cradle of this embodiment comprises a second generally parallelepipedic, here cubic, housing 101 fastened to the front wall 104 of the first receiving housing 100 such that the front wall 104 of the first housing 101 is common to the first housing 100 and the second housing 101.

Here, the generally parallelepipedic second receiving housing 101 has five walls, including a portion of the front wall 104, and a second upper opening 106 adapted for insertion into the second housing 101 of an experimentation system, for example an accelerometer.

Here, the first receiving housing 100 and the second receiving housing 101 are made of the same material as the rest of the device 1, here metal, and more particularly in this example, titanium. Thus, the walls of the receiving housings 100 and 101 provide electromagnetic isolation. In particular, electromagnetic emissions from an accelerometer inserted in the second housing 101 could not interfere with the operation of an electrical connector inserted in the first housing 100, and vice versa.

The protective enclosure 102 comprises a first protective wall 107 and a second protective wall 108, each of which extends here from the first receiving housing 100 to the arm 126. Each protective wall is also in contact with the base 2. The protective enclosure also comprises the first housing 100. The first housing 100 acts as a third protective wall.

The device 1 here comprises an arm 126 which is U-shaped, that is, it has two branches 109, 110 which extend from the base 2 and which meet at a common end 111 connected to a connection element, here a restraining head 133. The two branches 109, 110 of the arm 126 define the auxiliary observation frame 103. This auxiliary observation frame 103 allows visual access through the arm 126. In particular here, the auxiliary observation frame 103 allows visual access to the portion of the base 2 located inside the protective enclosure 102.

In this embodiment, the device 1 comprises an observation frame 127 located in the protective enclosure 102. The observation frame 127 is here formed by a recess 113 of generally rectangular shape formed in an edge of the base 2, here inside the enclosure 102, and by the auxiliary observation frame 103. In other words, the observation frame 127 extends partly into the base 2 and partly into the arm 126.

Alternatively, it would be possible for the observation frame 127 and the auxiliary observation frame 103 to be separate. For example, in some embodiments, the two branches 109, 110 of the arm 126 comprise a common second end fastened to the base 2.

Here, the device 1 has, as a receiving cradle, a receiving groove 128 adapted to receive a ground wire, for example connected to the ground circuit of an experiment apparatus, which allows the device 1 to be electrically connected to ground.

The device has two threaded holes 114, 115 as means for fastening weights for modifying the center of gravity of the device, adapted for example to receive weighted rods. Such rods make it possible to modify the balance of the animal equipped with the device.

The device 1 according to this embodiment further comprises means for fastening protective covers.

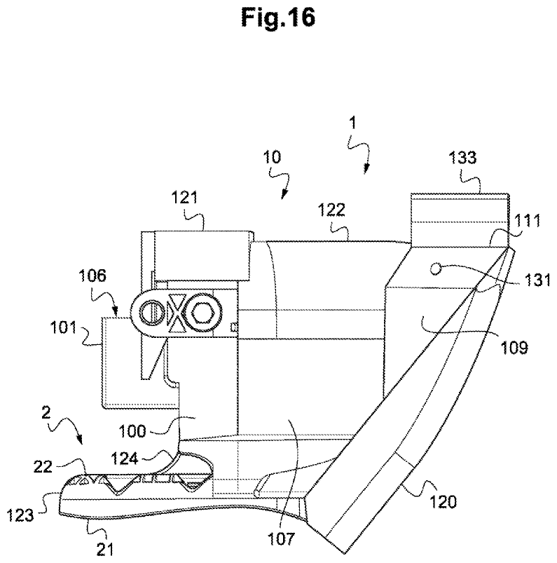

Thus, the arm 126 comprises a fastening groove 112 extending along each branch 109, 110 and over the common end 111. The fastening groove 112 is adapted to receive and hold a corresponding tab of a first protective cover 120 configured to obstruct the auxiliary observation frame 103, as shown in FIG. 16.

Two fastening means 116, 117 of a second protective cover 121 adapted to obstruct the first upper opening 105 of the first housing 100 are formed by protrusions extending from the front face 104.

Two side tabs 118, 119 that extend along each of the protective walls 107, 108 are each configured to cooperate with a corresponding groove in a third protective cover 122 that is configured to obstruct the protective enclosure 102.

Two holes 131, 132 through the arm 126 serve here as observation frames and as elements for connection to an experimentation system. In particular, the holes 131, 132 are each adapted to receive an optical fiber (not shown) by inserting one end of the fiber into the hole.

FIG. 16 shows the device 1 equipped with the first protective cover 120, the second protective cover 121 and the third protective cover 122. In this embodiment, the covers are made of plastic and covered with a metal layer. The covers 120, 121, 122 are therefore electromagnetically insulating. Alternatively, the covers could be entirely metallic.

The means of fastening the covers described here are by no means limiting and the covers can be fastened to the device 1 by any appropriate means.

1-24. (canceled)

25. A device for connecting a laboratory animal to at least one experimentation system, comprising a body provided with
a base for fastening to a bone surface of the animal,
at least one element for connection to the experimentation system,
wherein the base comprises a perforated fastening structure which has a proximal face with a shape complementary to that of the bone surface and opposite the proximal face, a distal face, and the perforated fastening structure delimits at least two fastening openings emerging at the proximal and distal faces.

26. The device according to claim 25, wherein the base comprises at least one reinforcing rib from which the perforated fastening structure extends.

27. The device according to claim 25, wherein the perforated fastening structure comprises a lattice the branches of which at least partially delimit the fastening openings.

28. The device according to claim 25, wherein the base comprises at least one observation frame which emerges at the proximal and distal faces and which has a larger passage cross-section than the passage cross-section of the fastening openings.

29. The device according to claim 25, wherein each fastening opening has a smaller passage cross-section at the proximal face than the passage cross-section of the opening in at least one other level on the fastening opening.

30. The device according to claim 25, wherein each fastening opening has a peripheral wall which converges towards the proximal face.

31. The device according to claim 25, wherein the proximal face has a generally concave shape.

32. The device according to claim 25, wherein the body comprises, as a connection element, at least one receiving cradle of an experimentation system.

33. The device according to claim 32, wherein said at least one receiving cradle is configured to provide electromagnetic isolation to the experimentation system.

34. The device according to claim 25, wherein the body comprises, as a connection element, a restraining head to an external immobilization system.

35. The device according to claim 34, wherein the restraining head has a dovetail shape intended to be inserted in a complementary groove of the immobilization system.

36. The device according to claim 34, wherein the body comprises an arm connecting the fastening base to the restraining head.

37. The device according to claim 36, wherein the arm has a box-like structure.

38. The device according to claim 36, wherein the arm has a lattice structure.

39. The device according to claim 36, wherein the straight cross-section of the arm increases from the fastening base to the restraining head.

40. The device according to claim 36, wherein the arm extends in a sagittal plane of the body of the device.

41. The device according to claim 40, wherein the arm extends along an axis which forms in the sagittal plane a non-zero angle with a normal to the proximal face of the fastening base.

42. The device according to claim 36, wherein the arm comprises an auxiliary observation frame configured to provide visual access to the fastening base.

43. The device according to claim 42, wherein the observation frame extends into the arm.

44. The device according to claim 25, comprising means for fastening a protective cover.

45. The device according to claim 25, comprising at least one means for fastening a ballast for modifying the center of gravity of the device.

46. The method of fastening the device according to claim 25 onto a laboratory animal, the method comprising
applying a cement to the proximal face,
placing the fastening base onto the bone surface of the laboratory animal so that the proximal face conforms to the bone surface,
curing the cement.

47. The method according to claim 46, wherein the cement is a light-curing cement and that the curing comprises illumination of the cement at least through the fastening openings.

48. The method according to claim 46, comprising applying cement in contact with a peripheral wall of at least one of the fastening openings.
